(19) United States
(12) Patent Application Publication
(10) Pub. No.: US 2026/0100178 A1
(43) Pub. Date: Apr. 9, 2026

(54) DAMPING MECHANISM AND HEADSET

(71) Applicant: Luxshare Precision Industry Company Limited, Shenzhen (CN)

(72) Inventor: Xiangxiang Duan, SHENZHEN (CN)

(73) Assignee: Luxshare Precision Industry Company Limited, Shenzhen (CN)

(21) Appl. No.: 19/018,893

(22) Filed: Jan. 13, 2025

(30) Foreign Application Priority Data
Oct. 9, 2024 (CN) 202411405414.2

(51) Int. Cl. G10K 11/16; H04R 1/10

(52) U.S. Cl. CPC G10K 11/161; H04R 1/105

(57) ABSTRACT

A damping mechanism includes a support member and a damping assembly. A sliding chute and a first through hole communicated with the sliding chute are disposed at the support member. The damping assembly is capable of dividing the sliding chute into an adjustment cavity and a balance cavity, where the balance cavity is communicated with an outside, one end of the damping assembly is slidable in the sliding chute, an end of the damping assembly extending into the sliding chute is a sealing end, the sealing end and an end of the sliding chute facing the first through hole form the adjustment cavity, the adjustment cavity is communicated with the outside via the first through hole, and when the damping assembly slides in the sliding chute, a pressure in the adjustment cavity changes, and damping is generated.

### CROSS-REFERENCE TO RELATED APPLICATION

This application claims priority to Chinese Patent Application No. 202411405414.2, filed on Oct. 9, 2024, the disclosure of which is incorporated herein by reference in its entirety.

### TECHNICAL FIELD

The present disclosure relates to the technical field of headsets and, in particular, to a damping mechanism and a headset.

### BACKGROUND

A headset, just as its name implies, is a type of earphone that is worn on a head rather than inserted into ear canals, differing from an in-ear plug. The headset consists of two portions: a signal emitter and a headset (generally a moving-coil headset) with an apparatus for receiving and amplifying a signal.

In the related art, “silicone rubber ring and sliding arm mechanism” is mainly used in a sliding arm mechanism of a headset on a market to implement a function of moving the sliding arm of the headset up and down. An interference fit between the silicone rubber ring and the metal or plastic sliding arm is mainly used to form a frictional damping force. An operator needs to adjust a hardness and interference amount of the silicone rubber to obtain a satisfactory damping force. Therefore, a relatively high requirement is imposed on the hardness of the silicone rubber ring and the fit accuracy between the silicone rubber ring and the sliding arm, resulting in a relatively high material cost. Moreover, when the silicone rubber ring is slidably engaged with the metal or plastic sliding arm, a sense of resistance is easily generated, and a damping effect is relatively poor, resulting in bad usage experience of a user.

### SUMMARY

An object of the present disclosure is to provide a damping mechanism with a better damping effect and a lower material cost.

To achieve the object, the present disclosure adopts the technical solutions below.

A damping mechanism includes a support member and a damping assembly.

A sliding chute and a first through hole communicated with the sliding chute are disposed at the support member.

The damping assembly is capable of dividing the sliding chute into an adjustment cavity and a balance cavity, where the balance cavity is communicated with an outside, one end of the damping assembly is slidable in the sliding chute, an end of the damping assembly extending into the sliding chute is a sealing end, the sealing end and an end of the sliding chute facing the first through hole form the adjustment cavity, the adjustment cavity is communicated with the outside via the first through hole, and when the damping assembly slides in the sliding chute, a pressure in the adjustment cavity changes, and damping is generated.

Another object of the present disclosure is to provide a headset with a better damping effect and a lower material cost.

To achieve the object, the present disclosure adopts the technical solutions below.

A headset includes a headset body and the damping mechanism described above, where the damping mechanism is disposed on the headset body.

### BRIEF DESCRIPTION OF DRAWINGS

FIG. 1 is an axonometric view of a headset body according to an embodiment of the present disclosure.

FIG. 2 is a side view of a headset body according to an embodiment of the present disclosure.

FIG. 3 is a sectional view taken along A-A of FIG. 2.

FIG. 4 is a partial enlarged view of part B of FIG. 3.

FIG. 5 is a partial enlarged view of part C of FIG. 3.

### REFERENCE LIST

100 headset body
1 support member
11 sliding chute
111 adjustment cavity
112 balance cavity
12 first through hole
13 connection groove
2 damping assembly
21 damping member
211 locking slot
22 sliding member
221 protruding block
30 pressure adjustment assembly
3 breathable member
4 fixing member
41 second through hole
5 limit member

### DETAILED DESCRIPTION

The present disclosure is further described below in detail in conjunction with drawings and embodiments. It is to be understood that the embodiments described herein are intended to illustrate and not to limit the present disclosure. Additionally, it is to be noted that for ease of description, only part, not all, of structures related to the present disclosure are illustrated in the drawings.

In the description of the present disclosure, terms “joined”, “connected”, and “fixed” are to be understood in a broad sense unless otherwise expressly specified and limited. For example, the term “connected” may refer to “fixedly connected”, “detachably connected”, or “integrated”, may refer to “mechanically connected” or “electrically connected”, may refer to “connected directly” or “connected indirectly through an intermediary”, or may refer to “connected inside two elements” or “an interaction relation between two elements”. For those of ordinary skill in the art, specific meanings of the preceding terms in the present disclosure may be understood based on specific situations.

In the present disclosure, unless otherwise expressly specified and limited, when a first feature is described as “above” or “below” a second feature, the first feature and the second feature may be in direct contact, or the first feature and the second feature may be in contact via another feature between the two features instead of being in direct contact. Moreover, when the first feature is described as being “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of this embodiment, the orientation or position relationships indicated by terms “above”, “below”, “right” and the like are based on the orientation or position relationships shown in the drawings, merely for ease of description and simplifying operation, and these relationships do not indicate or imply that the referred device or element has a specific orientation and is constructed and operated in a specific orientation, and thus they are not to be construed as limiting the present disclosure. In addition, the terms “first” and “second” are only used for distinguishing between descriptions and have no special meanings.

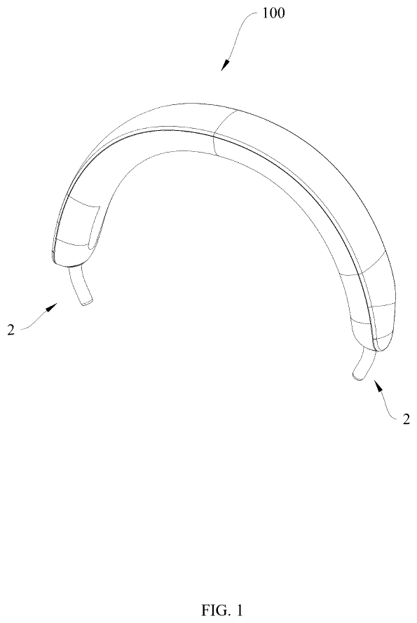

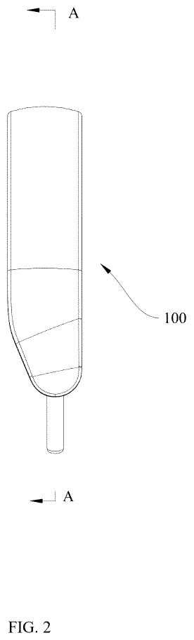

As shown in FIGS. 1 to 5, this embodiment provides a damping mechanism. The damping mechanism includes a support member 1 and a damping assembly 2. The support member 1 is provided with a sliding chute 11 and a first through hole 12 communicated with the sliding chute 11. The damping assembly 2 is capable of dividing the sliding chute 11 into an adjustment cavity 111 and a balance cavity 112, where the balance cavity 112 is communicated with an outside, one end of the damping assembly 2 is slidable in the sliding chute 11, an end of the damping assembly 2 extending into the sliding chute 11 is a sealing end, the sealing end and an end of the sliding chute 11 facing the first through hole 12 form the adjustment cavity 111, the adjustment cavity 111 is communicated with the outside via the first through hole 12, and when the damping assembly 2 slides in the sliding chute 11, a pressure in the adjustment cavity 111 changes, and damping is generated.

In this embodiment, the support member 1 is provided with the sliding chute 11 and the first through hole 12 communicated with the sliding chute 11, the damping assembly 2 is capable of dividing the sliding chute 11 into the adjustment cavity 111 and the balance cavity 112, and the balance cavity 112 is communicated with the outside so that a user can smoothly pull out the damping assembly 2 from the sliding chute 11 via the balance cavity 112 or push the damping assembly 2 into the sliding chute 11, thereby reducing a sense of resistance and improving the user experience. One end of the damping assembly 2 is slidable in the sliding chute 11, the end of the damping assembly 2 extending into the sliding chute 11 is the sealing end, the sealing end and the end of the sliding chute 11 facing the first through hole 12 form the adjustment cavity 111, and the adjustment cavity 111 is communicated with the outside via the first through hole 12, thereby ensuring that a gas in the adjustment cavity 111 can be smoothly exchanged with a gas in the outside and ensuring that the damping assembly 2 can be slid smoothly in the sliding chute 11. When the damping assembly 2 slides in the sliding chute 11, the gas in the adjustment cavity 111 is compressed or expanded so that the pressure in the adjustment cavity 111 changes. When the pressure in the adjustment cavity 111 changes, the damping assembly 2 is moved relative to the support member 1 to generate damping without the need for a complex and accurate mechanical structure to generate the damping effect, thereby reducing a requirement for the fit accuracy between the support member 1 and the damping assembly 2 and saving the material cost. Disposed in the above manners, the damping mechanism in this embodiment has a better damping effect and a lower material cost.

A specific structure of the damping mechanism is described below.

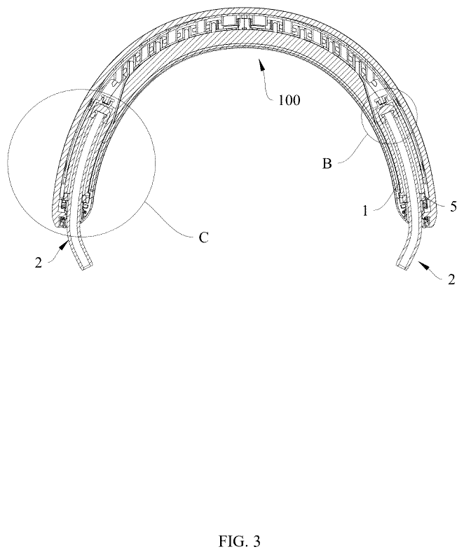

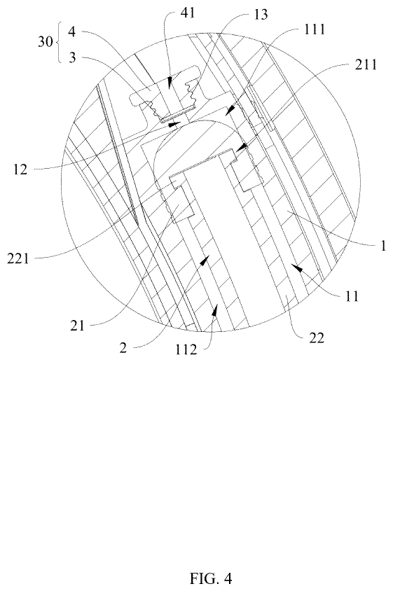

In an embodiment, as shown in FIGS. 3 and 4, the damping mechanism further includes a pressure adjustment assembly 30, where the pressure adjustment assembly 30 is disposed at the first through hole 12 and is capable of adjusting a magnitude of a gas flow speed between the adjustment cavity 111 and an outside. The flow speed for the gas to pass through the first through hole 12 is adjusted, thereby balancing the sliding smoothness and the sense of damping when the damping assembly 2 slides in the sliding chute 11 and ensuring that the user can feel a sufficient resistance without feeling laborious due to excessive damping when adjusting a position of the damping assembly 2.

In an embodiment, as shown in FIG. 4, the pressure adjustment assembly 30 includes a breathable member 3, where the breathable member 3 covers an outside of the first through hole 12 so that the adjustment cavity 111 can smoothly perform gas exchange with the outside via the first through hole 12 and the breathable member 3. Moreover, parameters such as the specific material, the size of the aperture and the number of holes of the breathable member 3 are designed carefully, thereby accurately controlling the gas flow speed and contributing to the accurate adjustment of the sense of damping. A breathable membrane or a breathable plate, for example, a polyurethane breathable membrane or a polytetrafluoroethylene breathable membrane, may be selected as the breathable member 3. The specific structure and material of the breathable member 3 are not limited too much here.

In an embodiment, as shown in FIG. 4, the pressure adjustment assembly 30 further includes a fixing member 4, where the fixing member 4 is fixed to the support member 1 and is pressed against the breathable member 3 to adjust the magnitude of the gas flow speed between the adjustment cavity 111 and the outside so that the gas flow is adjusted more accurately. It may be understood that the flow speed for the gas to pass through the breathable member 3 is higher when a pressure generated when the fixing member 4 is pressed against the breathable member 3 is relatively small and the flow speed for the gas to pass through the breathable member 3 is relatively low when the pressure between the fixing member 4 and the breathable member 3 is relatively large. The magnitude of the gas flow speed between the adjustment cavity 111 and the outside can be adjusted in the above manner, thereby causing an air pressure in the adjustment cavity 111 to change and meeting a requirement of the user for the sense of damping generated when the damping assembly 2 is moved relative to the sliding chute 11. A second through hole 41 communicated with the first through hole 12 is disposed on the fixing member 4, one end of the second through hole 41 faces the breathable member 3, and the other end of the second through hole 41 is communicated with the outside so that the gas in the adjustment cavity 111 can be smoothly exchanged with the gas in the outside via the first through hole 12, the breathable member 3 and the second through hole 41.

In this embodiment, the second through hole 41 is aligned with the first through hole 12 to ensure that the gas flowing via the first through hole 12 can be smoothly exchanged with the gas in the outside via the second through hole 41. In other embodiments, the second through hole 41 may be misaligned with the first through hole 12 as long as a communication channel exists between the second through hole 41 and the first through hole 12 and can implement the above functions and effects.

In an embodiment, in this embodiment, the fixing member 4 is a plastic tail plug light in texture with a material easy to take and process and a relatively low cost. In other embodiments, the fixing member 4 is a rubber tail plug. The specific structure and material of the fixing member 4 are not limited too much here as long as the above functions and effects can be implemented.

In an embodiment, as shown in FIG. 4, a connecting groove 13 is disposed on the support member 1, and the fixing member 4 is communicated with the connection groove 13 via threaded connection to adjust a magnitude of a pressing force of the fixing member 4 against the breathable member 3. This connection manner not only has a relatively high stability and reliability but also facilitates the installation and disassembly of the fixing member 4, thereby contributing to reducing a maintenance cost and improving work efficiency. In addition, when a tightening force between the fixing member 4 and the connection groove 13 is relatively small, the pressure generated when the fixing member 4 is pressed against the breathable member 3 is relatively small, the flow speed for the gas to pass through the breathable member 3 is higher, and the sense of damping generated when the damping assembly 2 is moved relative to the sliding chute 11 is relatively small; when the tightening force between the fixing member 4 and the connection groove 13 is relatively large, the pressure generated when the fixing member 4 is pressed against the breathable member 3 is relatively large, the flow speed for the gas to pass through the breathable member 3 is relatively low, and the sense of damping generated when the damping assembly 2 is moved relative to the sliding chute 11 is relatively large.

In an embodiment, one end of the first through hole 12 is communicated with the adjustment cavity 111, the other end of the first through hole 12 is communicated with the connection groove 13, and the breathable member 3 is disposed on an end of the connection groove 13 facing the adjustment cavity 111. When the fixing member 4 is communicated with the connection groove 13 via the screw thread, the fixing member 4 can abut against the breathable member 3, and the breathable member 3 is tightly pressed against at the other end of the first through hole 12 so that the gas in the outside can be smoothly exchanged with the gas in the adjustment cavity 111 via the second through hole 41, the breathable member 3 and the first through hole 12 and the flow speed of the air is adjusted through a pressing effect of the fixing member 4 on the breathable member 3 to meet the requirement for the damping generated when the damping assembly 2 slides.

In an embodiment, as shown in FIGS. 1 to 5, the damping assembly 2 includes a damping member 21 and a sliding member 22, where the damping member 21 is the sealing end and is slidable in the sliding chute 11, and the damping member 21 is sleeved on the sliding member 22 and resiliently abuts against an inner wall of the sliding chute 11. The user can pull out the sliding member 22 from the sliding chute 11 or push the sliding member 22 into the sliding chute 11, thereby driving the damping member 21 to slide relative to the inner wall of the sliding chute 11 and generating the sense of damping through a friction effect between the damping member 21 and the inner wall of the sliding chute 11.

In an embodiment, in this embodiment, the damping member 21 is a silicone rubber head, that is, the sealing end of the damping assembly 2. The sliding member 22 is a stainless steel rod, and the silicone rubber head is sleeved on an end of the stainless steel rod and is slidable in the sliding chute 11. The silicone rubber head can generate a sufficient damping force when being in contact with the inner wall of the sliding chute 11, thereby slowing down a movement speed of the stainless steel rod and generating a relatively good sense of damping. In other embodiments, the damping member 21 is a plastic sleeve, and the sliding member 22 is a plastic rod. The plastic sleeve is sleeved on an end of the plastic rod and is slidably connected to the sliding chute 11 to generate the sense of damping through a friction effect between the plastic and the inner wall of the sliding chute 11. It may be understood that the specific structures and materials of the damping member 21 and the sliding member 22 are not limited as long as the above functions and effects can be implemented.

In an embodiment, as shown in FIG. 4, the sliding member 22 and the inner wall of the sliding chute 11 are disposed at an interval to form a balance cavity 112. Since the user generally holds the sliding member 22 to pull or push the sliding member 22, dirt is easily generated on a surface of the sliding member 22. The sliding member 22 and the inner wall of the sliding chute 11 are disposed at an interval so that the sliding member 22 is not in contact the inner wall of the sliding chute 11, thereby improving the user experience and preventing the dirt from affecting the sliding damping of the damping assembly 2 relative to the support member 1. Moreover, the damping member 21 resiliently abuts against the inner wall of the sliding chute 11, thereby pushing out the dirt in the balance cavity 112 formed since the sliding member 22 and the inner wall of the sliding chute 11 are disposed at an interval.

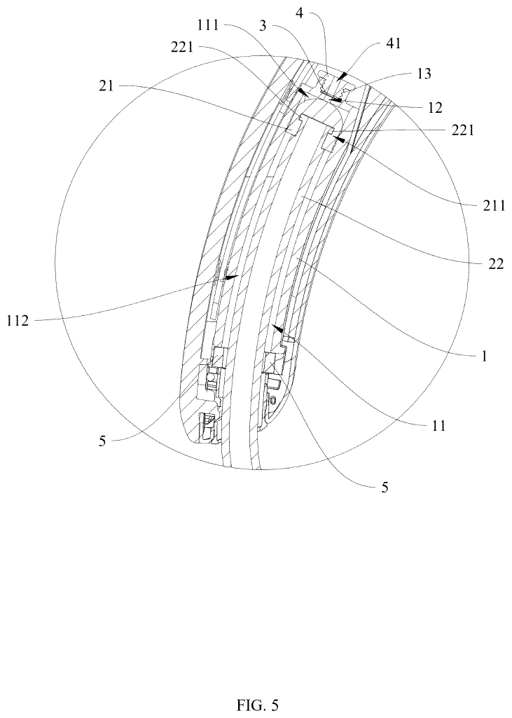

In an embodiment, as shown in FIGS. 4 and 5, an outer wall surface of the damping member 21 that resiliently abuts against the inner wall of the sliding chute 11 is disposed to be uneven to increase the frictional resistance between the damping member 21 and the inner wall of the sliding chute 11 and improve the damping sense of a hand so that the damping member 21 is not easy to fall off. A protruding block 221 is disposed on one of the sliding member 22 and the damping member 21, and a locking slot 211 engaged with the protruding block 221 is disposed on the other of the sliding member 22 and the damping member 21. In this manner, a connection strength between the damping member 21 and the sliding member 22 can be enhanced, thereby preventing relative sliding or disengagement in a movement process. Of course, in other embodiments, a dovetail groove structure may be further disposed between the sliding member 22 and the damping member 21 to enhance the fixation between the sliding member 22 and the damping member 21.

In an embodiment, in this embodiment, the protruding block 221 is disposed on the sliding member 22, and the locking slot 211 is disposed on the damping member 21. The protruding block 221 is engaged with the locking slot 211 so that the damping member 21 can be stably installed on the sliding member 22. In other embodiments, the protruding block 221 is disposed on the damping member 21, and the locking slot 211 is disposed on the sliding member 22. That is, the specific positions of the protruding block 221 and the locking slot 211 are not limited too much here as long as the above functions and effects can be implemented.

In an embodiment, as shown in FIGS. 1 to 5, the damping mechanism further includes a limit member 5, where the limit member 5 protrudes inwardly from the inner wall of the sliding chute 11 so that the damping assembly 2 is stopped by the limit member 5 when sliding in the sliding chute 11, thereby limiting a sliding process of the damping assembly 2 and preventing the damping assembly 2 from being completely pulling out from the sliding chute 11. It may be understood that an inner wall surface of the limit member 5 protrudes from the inner wall of the sliding chute 11. Since the damping member 21 is sleeved on the sliding member 22, protrudes from a dimension of the sliding member 22 in a radial direction and slidably abuts against the inner wall of the sliding chute 11 and a gap exists between the sliding member 22 and the inner wall of the sliding chute 11 to form the balance cavity 112. When the damping assembly 2 slides to the limit member 5, a radial dimension of the damping member 21 is greater than that of the sliding member 22 and abuts against the inner wall of the sliding chute 11, and the limit member 5 protrudes inwardly from the inner wall of the sliding chute 11 so that the damping member 21 is stopped by the limit member 5 to prevent the damping member 21 from falling off from the sliding chute 11 due to an excessive force.

In an embodiment, in this embodiment, the limit member 5 is a limit ring and is made of plastic. The limit ring limits the sliding of the damping member 21 to prevent the damping assembly 2 from disengaging from the sliding chute 11. Moreover, using the limit ring made of plastic can save the material cost and make the overall structure lighter. In other embodiments, the block-shaped limit member 5 made of hard silicone not only has a relatively light mass but can also limit the damping assembly 2. It may be understood that the specific structure and material of the limit member 5 are not limited as long as the above functions and effects can be implemented.

A specific work process of the damping mechanism is described below.

As shown in FIGS. 1 to 5, when the damping assembly 2 slides in the sliding chute 11, the gas in the adjustment cavity 111 is compressed or expanded so that the pressure in the adjustment cavity 111 changes. When the pressure in the adjustment cavity 111 changes, the damping assembly 2 is moved relative to the support member 1 to generate damping. It may be understood that when the user pulls the sliding member 22, the sliding member 22 drives the damping member 21 to slide in the sliding chute 11 so that the adjustment cavity 111 extracts the air from the outside via the breathable member 3 to form a negative pressure damping force, and when the user pushes the sliding member 22 back into the sliding chute 11, the sealing end compresses the air in the adjustment cavity 111 to form a positive pressure damping force. When the user wants to adjust a magnitude of the damping force, the fixing member 4 is screwed, and the magnitude of the pressure generated when the fixing member 4 is pressed against the breathable member 3 is adjusted, thereby adjusting the flow speed for the gas to pass through the breathable member 3 and affecting the magnitude of the damping force generated when the damping assembly 2 slides relative to the support member 1.

As shown in FIGS. 1 to 5, this embodiment further provides a headset. The headset includes a headset body 100 and the damping mechanism. The damping mechanism is disposed on the headset body 100 and can generate a relatively good sense of damping. Moreover, the sense of damping is mainly achieved in a manner of the compression and expansion of the gas in the adjustment cavity 111 by the sealing end without the need for a complex and accurate mechanical structure to generate the damping effect, thereby reducing a requirement for the fit accuracy between the support member 1 and the damping assembly 2 and reducing the material cost.

In an embodiment, as shown in FIGS. 3 and 4, the headset body 100 extends in an arc shape, and one headset body 100 is provided with two damping mechanisms and the two damping mechanisms are disposed on two ends of the headset body 100, respectively. The pressure adjustment assembly 30 is capable of adjusting the magnitude of the gas flow speed between the adjustment cavity 111 and the outside, thereby balancing the sliding smoothness and the sense of damping when the damping assembly 2 slides in the sliding chute 11 and optimizing the problem of poor consistency during the sliding of damping assemblies 2 on the left and right ends of the headset body 100. Moreover, the sliding member 22 and the inner wall of the sliding chute 11 are disposed at an interval, thereby contributing to improving the damping effect and preventing the dirt on the sliding member 22 from directly being in contact with the inner wall of the sliding chute 11 and affecting the sense of damping.

Apparently, the preceding embodiments of the present disclosure are illustrative of the present disclosure and are not intended to limit embodiments of the present disclosure. Those of ordinary skill in the art can make various apparent modifications, adaptations, and substitutions without departing from the scope of the present disclosure. All embodiments do not need to be and cannot be exhausted herein. Any modifications, equivalent substitutions, and improvements made within the spirit and principle of the present disclosure fall within the scope of the claims of the present disclosure.

What is claimed is:

1. A damping mechanism, comprising:
a support member provided with a sliding chute and a first through hole communicated with the sliding chute; and
a damping assembly capable of dividing the sliding chute into an adjustment cavity and a balance cavity, wherein the balance cavity is communicated with an outside, one end of the damping assembly is slidable in the sliding chute, an end of the damping assembly extending into the sliding chute is a sealing end, the sealing end and an end of the sliding chute facing the first through hole form the adjustment cavity, the adjustment cavity is communicated with the outside via the first through hole, and when the damping assembly slides in the sliding chute, a pressure in the adjustment cavity changes, and damping is generated.

2. The damping mechanism according to claim 1, further comprising a pressure adjustment assembly, wherein the pressure adjustment assembly is disposed at the first through hole and is capable of adjusting a magnitude of a gas flow speed between the adjustment cavity and the outside.

3. The damping mechanism according to claim 2, wherein the pressure adjustment assembly comprises a breathable member, wherein the breathable member covers an outer side of the first through hole.

4. The damping mechanism according to claim 3, wherein the pressure adjustment assembly further comprises a fixing member, wherein the fixing member is fixed to the support member and is pressed against the breathable member to adjust the magnitude of the gas flow speed between the adjustment cavity and the outside, a second through hole communicated with the first through hole is disposed on the fixing member, one end of the second through hole faces the breathable member, and the other end of the second through hole is communicated with the outside.

5. The damping mechanism according to claim 4, wherein a connection groove is disposed on the support member, and the fixing member is communicated with the connection groove via threaded connection to adjust a magnitude of a pressing force of the fixing member against the breathable member.

6. The damping mechanism according to claim 1, wherein the damping assembly comprises a damping member and a sliding member, wherein the damping member is the sealing end and is slidable in the sliding chute, and the damping member is sleeved on the sliding member and resiliently abuts against an inner wall of the sliding chute.

7. The damping mechanism according to claim 6, wherein the sliding member and the inner wall of the sliding chute are disposed at an interval to form the balance cavity.

8. The damping mechanism according to claim 6, wherein an outer wall surface of the damping member that resiliently abuts against the inner wall of the sliding chute is disposed to be uneven, a protruding block is disposed on one of the sliding member and the damping member, and a locking slot engaged with the protruding block is disposed on the other of the sliding member and the damping member.

9. The damping mechanism according to claim 1, further comprising a limit member, wherein the limit member protrudes inwardly from the inner wall of the sliding chute so that the damping assembly is stopped by the limit member when sliding in the sliding chute.

10. The damping mechanism according to claim 2, further comprising a limit member, wherein the limit member protrudes inwardly from the inner wall of the sliding chute so that the damping assembly is stopped by the limit member when sliding in the sliding chute.

11. The damping mechanism according to claim 3, further comprising a limit member, wherein the limit member protrudes inwardly from the inner wall of the sliding chute so that the damping assembly is stopped by the limit member when sliding in the sliding chute.

12. A headset, comprising a headset body and a damping mechanism, wherein the damping mechanism is disposed on the headset body, and the damping mechanism comprises:
a support member provided with a sliding chute and a first through hole communicated with the sliding chute; and
a damping assembly capable of dividing the sliding chute into an adjustment cavity and a balance cavity, wherein the balance cavity is communicated with an outside, one end of the damping assembly is slidable in the sliding chute, an end of the damping assembly extending into the sliding chute is a sealing end, the sealing end and an end of the sliding chute facing the first through hole form the adjustment cavity, the adjustment cavity is communicated with the outside via the first through hole, and when the damping assembly slides in the sliding chute, a pressure in the adjustment cavity changes, and damping is generated.

13. The headset according to claim 12, wherein the damping mechanism further comprises a pressure adjustment assembly, wherein the pressure adjustment assembly is disposed at the first through hole and is capable of adjusting a magnitude of a gas flow speed between the adjustment cavity and the outside.

14. The headset according to claim 13, wherein the pressure adjustment assembly comprises a breathable member, wherein the breathable member covers an outer side of the first through hole.

15. The headset according to claim 14, wherein the pressure adjustment assembly further comprises a fixing member, wherein the fixing member is fixed to the support member and is pressed against the breathable member to adjust the magnitude of the gas flow speed between the adjustment cavity and the outside, a second through hole communicated with the first through hole is disposed on the fixing member, one end of the second through hole faces the breathable member, and the other end of the second through hole is communicated with the outside.

16. The headset according to claim 15, wherein a connection groove is disposed on the support member, and the fixing member is communicated with the connection groove via threaded connection to adjust a magnitude of a pressing force of the fixing member against the breathable member.

17. The headset according to claim 12, wherein the damping assembly comprises a damping member and a sliding member, wherein the damping member is the sealing end and is slidable in the sliding chute, and the damping member is sleeved on the sliding member and resiliently abuts against an inner wall of the sliding chute.

18. The headset according to claim 17, wherein the sliding member and the inner wall of the sliding chute are disposed at an interval to form the balance cavity.

19. The headset according to claim 17, wherein an outer wall surface of the damping member that resiliently abuts against the inner wall of the sliding chute is disposed to be uneven, a protruding block is disposed on one of the sliding member and the damping member, and a locking slot engaged with the protruding block is disposed on the other of the sliding member and the damping member.

20. The headset according to claim 12, wherein the damping mechanism further comprises a limit member, wherein the limit member protrudes inwardly from the inner wall of the sliding chute so that the damping assembly is stopped by the limit member when sliding in the sliding chute.
